(19) United States
(12) Patent Application Publication
(10) Pub. No.: US 2023/0292307 A1
(43) Pub. Date: Sep. 14, 2023

(54) METHOD AND DEVICE USED FOR WIRELESS COMMUNICATION

(71) Applicants: Jinfang ZHANG, Shanghai (CN); Xiaobo ZHANG, Shanghai (CN)

(72) Inventors: Jinfang ZHANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/117,484

(22) Filed: Mar. 6, 2023

(30) Foreign Application Priority Data
Mar. 10, 2022 (CN) 202210233479.8

(51) Int. Cl. H04W 72/1263; H04W 76/20; H04L 1/1812; H04W 72/23

(52) U.S. Cl. CPC H04W 72/1263; H04W 76/20; H04L 1/1812; H04W 72/23

(57) ABSTRACT

The present application provides a method and device for wireless communications. A first node receives a first signaling, the first signaling is used to activate a first scheduling, or the first signaling is used to de-activate a first scheduling; a first processor, as a response to receiving the first signaling, executes a first action, the first action is related to a current RRC state; wherein the phrase of the first action being related to a current RRC state comprises: for RRC_CONNECTED State and RRC_INACTIVE State, only when the current RRC state is RRC_CONNECTED State, the first action comprises transmitting a first HARQ-ACK on a first time-frequency resource block; the first scheduling is executed after being activated and before being deactivated. The present application can effectively support data transmission in RRC_INACTIVE State.

### CROSS REFERENCE TO RELATED APPLICATIONS

This application claims the priority benefit of Chinese Patent Application No. 202210233479.8, filed on March 10,2022, the full disclosure of which is incorporated herein by reference.

### BACKGROUND

### Technical Field

The present application relates to methods and devices in wireless communication systems, and in particular to a method and device supporting a transmission of data in Radio Resource Control (RRC)_INACTIVE State in wireless communications.

### Related Art

Radio Resource Control (RRC)_NACTIVE State is an RRC state newly introduced in NR. When a user enters into RRC_INACTIVE State, the user can reserve partial network configuration information. When services arrive, the user can transmit data by re-entering into RRC_CONNECTED State. Until Rel (version)-16, data transmission in RRC_INACTIVE State is not supported in 3rd Generation Partner Project (3GPP) Radio Access Network (RAN).

Data transmission comprises dynamic scheduling-based data transmission and non-dynamic scheduling-based data transmission. Non-dynamic scheduling comprises Semi-Persistent Scheduling (SPS) in downlink and Configured Grant Type 1 and Configured Grant Type 2 in uplink. For downlink semi-persistent scheduling, activating and storing downlink assignment or de-activating and clearing downlink assignment are indicated through a Layer 1 (L1) signaling; similarly, for Uplink Configured Grant Type 2, activating and storing uplink assignment or de-activating and clearing uplink assignment are indicated through an L1 signaling.

Application scenarios of future wireless communication systems are becoming increasingly diverse, with the rapid development of the Internet of Things (IoT), small data service will be an important service in future wireless communications. For small data transmission, signaling overhead of RRC state switch is greater than transmission overhead of small data, meanwhile, the power consumption overhead of the UE is also increased. Therefore, at 3GPP RAN #88e plenary, it was decided to start a Work Item (WI) standardization work for small data transmission (SDT) in RRC_INACTIVE State.

The one-to-many transmission characteristics of multicast/broadcast communications can significantly improve system performance and user experience in many important application scenarios, such as public security and mission critical, Vehicle-to-Everything (V2X) applications, software delivery, and group communications. To support multicast/broadcast communications, in Rel-17, 3GPP studies multicast/broadcast service (MBS) transmission when a User Equipment (UE) is in RRC_CONNECTED state. In order to further save UE power consumption, 3GPP began to discuss supporting MBS transmission when the UE is in RRC_INACTIVE State in Rel-18.

### SUMMARY

Inventors have found through researches that when a UE is in RRC_INACTIVE State, if the UE receives a non-dynamic scheduling signaling indicating activation or de-activation, whether to feed back a confirmation to a base station and how to feed back need to be studied.

The present application discloses a solution that, when a UE receives a non-dynamic scheduling signaling indicating activation or de-activation, actions to be executed are determined based on RRC state in which the UE is located, thus achieving the beneficial effect of effectively supporting data transmission in RRC_INACTIVE State. Although the present application was originally intended for a Uu air interface, it can also be applied to a PC5 air interface. Additionally, the adoption of a unified solution for various scenarios, including but not limited to uplink communication scenarios, contributes to the reduction of hardware complexity and costs. If no conflict is incurred, embodiments in the first node in the present application and the characteristics of the embodiments are also applicable to any other node, and vice versa. And the embodiments in the present application and the characteristics in the embodiments can be arbitrarily combined if there is no conflict. Particularly, for interpretations of the terminology, nouns, functions and variants (if not specified) in the present application, refer to definitions given in TS36 series, TS38 series and TS37 series of 3GPP specifications.

The present application provides a method in a first node for wireless communications, comprising:

receiving a first signaling, the first signaling being used to activate a first scheduling, or the first signaling being used to de-activate a first scheduling; and

as a response to receiving the first signaling, executing a first action, the first action being related to a current RRC state;

herein, the phrase of the first action being related to a current RRC state comprises: for RRC_CONNECTED State and RRC_INACTIVE State, only when the current RRC state is RRC_CONNECTED

State, the first action comprises transmitting a first HARQ-ACK on a first time-frequency resource block; the first scheduling is executed after being activated and before being de-activated.

In one embodiment, the above method of a first action being related to a current RRC state can increase the flexibility of the system.

In one embodiment, the above method ensures information synchronization between the base station and UE in RRC_CONNECTED State through transmitting a first Hybrid Automatic Repeat Request-ACKnowledgement (HARQ-ACK) to indicate that a base station receives a first signaling.

In one embodiment, the above method, by transmitting a first HARQ-ACK, prevents a UE from continuing to receive data on configuration information determined by a first scheduling when a first signaling is not received, thus avoiding the waste of the UE's power.

In one embodiment, the above method, by transmitting a first HARQ-ACK, prevents a UE from continuing to receive data on configuration information determined by a first scheduling when a first signaling is not received, and then executes an uplink HARQ feedback to incur signal interference.

According to one aspect of the present application, comprising:

when the current RRC state is RRC_INACTIVE State, the first action comprises transmitting first information on a second time-frequency resource block, there at least exists one Resource Element (RE) not belonging to the first time-frequency resource block and a second time-frequency resource block at the same time.

In one embodiment, the above method, through transmitting first information, indicates that a base station receives a first signaling, which can ensure the information synchronization between the base station and a UE in RRC_INACTIVE State.

According to one aspect of the present application, comprising:

the first information is a HARQ-ACK.

According to one aspect of the present application, comprising:

a transmission channel occupied by the first information comprises an Uplink Shared Channel (UL-SCH).

In one embodiment, the above method transmits first information through a UL-SCH, which can effectively support the scenario without configuring a HARQ feedback, thus improving the system robustness.

According to one aspect of the present application, comprising:

when the current RRC state is RRC_INACTIVE State, the first action comprising switching to a first RRC state;

herein, the first signaling is used to de-activate the first scheduling; the first RRC state is one of RRC_INACTIVE State or RRC_IDLE State.

In one embodiment, in the above method, by switching to a first RRC state, the beneficial effect of power saving can be achieved.

According to one aspect of the present application, comprising:

when the current RRC state is RRC_INACTIVE State, the first action comprises monitoring a second signaling in a first time window;

herein, the first signaling is used to de-activate the first scheduling; the second signaling is scheduled by a PDCCH addressed to a unicast Radio Network Temporary Identifier (RNTI).

In one embodiment, the above method re-configures the first node by receiving a second signaling, which can ensure the information synchronization between a base station and a UE in RRC_INACTIVE State.

According to one aspect of the present application, comprising:

receiving a first radio signal, the first scheduling being used to determine configuration information of the first radio signal, the configuration information comprises at least one of occupied frequency-domain resources, occupied time-domain resources, a Modulation and coding scheme (MCS) or a HARQ process number;

only an uplink feedback of an Negative ACKnowledgment (NACK) is executed for the first radio signal.

In one embodiment, when the first radio signal is not successfully received, a NACK is transmitted; when the first radio signal is successfully received, a transmission of an ACK is dropped.

In one embodiment, the above method supports NACK-only uplink feedback for a downlink transmission, thus saving feedback resources.

In one embodiment, the above method supports NACK-only uplink feedback for a downlink transmission, thus achieving the beneficial effects of power saving.

The present application provides a first node for wireless communications, comprising:

a first receiver, receiving a first signaling, the first signaling being used to activate a first scheduling, or the first signaling being used to de-activate a first scheduling; and

a first processor, as a response to receiving the first signaling, executing a first action, the first action being related to a current RRC state;

herein, the phrase of the first action being related to a current RRC state comprises: for RRC_CONNECTED State and RRC_INACTIVE State, only when the current RRC state is RRC_CONNECTED State, the first action comprises transmitting a first HARQ-ACK on a first time-frequency resource block; the first scheduling is executed after being activated and before being de-activated.

The present application provides a method in a second node for wireless communications, comprising:

transmitting a first signaling, the first signaling being used to activate a first scheduling, or the first signaling being used to de-activate a first scheduling;

herein, as a response to receiving the first signaling, a first action is executed, the first action is related to a current RRC state; the phrase of the first action being related to a current RRC state comprises: for RRC_CONNECTED State and RRC_INACTIVE State, only when the current RRC state is RRC_CONNECTED State, the first action comprises transmitting a first HARQ-ACK on a first time-frequency resource block; the first scheduling is executed after being activated and before being de-activated.

In one embodiment, the first action is executed at a receiver of the first signaling.

In one embodiment, the first action is related to a current RRC state of the receiver of the first signaling.

According to one aspect of the present application, comprising:

when the current RRC state is RRC_INACTIVE State, the first action comprises transmitting first information on a second time-frequency resource block, there at least exists one RE not belonging to the first time-frequency resource block and a second time-frequency resource block at the same time.

According to one aspect of the present application, comprising:

the first information is a HARQ-ACK.

According to one aspect of the present application, comprising:

a transmission channel occupied by the first information comprises a UL-SCH.

According to one aspect of the present application, comprising:

when the current RRC state is RRC_INACTIVE State, the first action comprising switching to a first RRC state;

herein, the first signaling is used to de-activate the first scheduling; the first RRC state is one of RRC_INACTIVE State or RRC_IDLE State.

According to one aspect of the present application, comprising:

when the current RRC state is RRC_INACTIVE State, the first action comprises monitoring a second signaling in a first time window;

herein, the first signaling is used to de-activate the first scheduling; the second signaling is scheduled by a PDCCH addressed to a unicast RNTI.

According to one aspect of the present application, comprising:

transmitting a first radio signal, the first scheduling being used to determine configuration information of the first radio signal, the configuration information comprising at least one of occupied frequency-domain resources, occupied time-domain resources, an MCS or a HARQ process number;

a NACK-only uplink feedback is received for the first radio signal.

The present application provides a second node for wireless communications, comprising:

a first transmitter, transmitting a first signaling, the first signaling being used to activate a first scheduling, or the first signaling being used to de-activate a first scheduling; and

herein, as a response to receiving the first signaling, a first action is executed, the first action is related to a current RRC state; the phrase of the first action being related to a current RRC state comprises: for RRC_CONNECTED State and RRC_INACTIVE State, only when the current RRC state is RRC_CONNECTED State, the first action comprises transmitting a first HARQ-ACK on a first time-frequency resource block; the first scheduling is executed after being activated and before being de-activated.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a transmission of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of hardware modules of a communication device according to one embodiment of the present application;

FIG. 5 illustrates a flowchart of radio signal transmission according to one embodiment of the present application;

FIG. 6 illustrates another flowchart of radio signal transmission according to one embodiment of the present application;

FIG. 7 illustrates a third flowchart of radio signal transmission according to one embodiment of the present application;

FIG. 8 illustrates a schematic diagram of switching to a first RRC state according to one embodiment of the present application;

FIG. 9 illustrates a structure block diagram of a processor in a first node according to one embodiment of the present application;

FIG. 10 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of transmission of a first node according to one embodiment of the present application, as shown in FIG. 1.

In embodiment 1, a first node 100 receives a first signaling in step 101, the first signaling is used to activate a first scheduling, or the first signaling is used to de-activate a first scheduling; as a response to receiving the first signaling in step 102, executes a first action, the first action is related to a current RRC state; herein, the phrase of the first action being related to a current RRC state comprises: for RRC_CONNECTED State and RRC_INACTIVE State, only when the current RRC state is RRC_CONNECTED State, the first action comprises transmitting a first HARQ-ACK on a first time-frequency resource block; the first scheduling is executed after being activated and before being de-activated.

In one embodiment, a first signaling is received via an air interface.

In one embodiment, the air interface is an NR air interface.

In one embodiment, the air interface is a Uu interface.

In one embodiment, the first signaling is an RRC sub-layer signaling.

In one embodiment, the first signaling is an RRCReconfiguration.

In one embodiment, the first signaling is a Medium Access Control (MAC) sublayer signaling.

In one embodiment, the first signaling is a MAC Control Element (CE).

In one embodiment, the first signaling is a physical-layer signaling.

In one embodiment, the first signaling is Downlink Control Information (DCI).

In one embodiment, the first signaling is a Physical Downlink Control Channel (PDCCH).

In one embodiment, the first signaling is a DL SPS assignment PDCCH.

In one embodiment, the first signaling is a configured UL grant Type 2 PDCCH.

In one embodiment, the first signaling is a PDCCH order.

In one embodiment, the first signaling is scrambled by a Configured Scheduling-Radio Network Temporary Identifier (CS-RNTI).

In one embodiment, a Cyclic Redundancy Check (CRC) of the first signaling is scrambled by the CS-RNTI.

In one embodiment, the CS-RNTI is used to identify the first node.

In one embodiment, the first signaling is scrambled by a Group-CS-RNTI (G-CS-RNTI).

In one embodiment, a CRC of the first signaling is scrambled by the G-CS-RNTI.

In one subembodiment of the above two embodiments, a target receiver of the first signaling comprises at least one node other than the first node.

In one subembodiment of the above two embodiments, the first signaling is received through multicast.

In one embodiment, the G-CS-RNTI is used to identify a multicast/broadcast service (MBS) session.

In one embodiment, the first signaling is used to activate a first scheduling.

In one embodiment, the phrase of activating a first scheduling comprises indicating a first scheduling.

In one embodiment, the phrase of activating a first scheduling comprises storing a first scheduling.

In one embodiment, the first signaling is used to de-activate a first scheduling.

In one embodiment, the phrase of de-activating a first scheduling comprises clearing a first scheduling.

In one embodiment, the phrase of de-activating a first scheduling comprises releasing a first scheduling.

In one embodiment, when the following three conditions are satisfied, the first signaling is used to activate the first scheduling, and the three conditions comprise: a format of the first signaling is one of DCI format 0_0, DCI format 0_1, or DCI format 0_2; a value of a HARQ process number field comprised in the first signaling is all zero; a value of a Redundancy Version (RV) field comprised in the first signaling is all zero.

In one embodiment, when the following three conditions are satisfied, the first signaling is used to activate the first scheduling, and the three conditions comprise: a format of the first signaling is one of DCI format 1_0 or DCI format 1_2; a value of a HARQ process number field comprised in the first signaling is all zero; a value of an RV field comprised in the first signaling is all zero.

In one embodiment, when the following three conditions are satisfied, the first signaling is used to activate the first scheduling, and the three conditions comprise: a format of the first signaling is DCI format 1_1; a value of a HARQ process number field comprised in the first signaling is all zero; a value of an RV field comprised in the first signaling for an enabled transport block is all zero.

In one embodiment, when the following five conditions are satisfied, the first signaling is used to de-activate the first scheduling, and the five conditions comprise: a format of the first signaling is one of DCI format 0_0, DCI format 0_1, or DCI format 0_2; a value of a HARQ process number field comprised in the first signaling is all zero; a value of an RV field comprised in the first signaling is all zero; a value of an MCS field comprised in the first signaling is all zero; for the case where it is 1 in Frequency Domain Resource Assignment (FDRA) type 2, a value of a Frequency Domain Resource Assignment field comprised in the first signaling is all zero, or for other cases, a value of the Frequency Domain Resource Assignment field comprised in the first signaling is all one.

In one embodiment, when the following five conditions are satisfied, the first signaling is used to de-activate the first scheduling, and the five conditions comprise: a format of the first signaling is one of DCI format 1_0, DCI format 1_1, or DCI format 1_2; a value of a HARQ process number field comprised in the first signaling is all zero; a value of an RV field comprised in the first signaling is all zero; a value of an MCS field comprised in the first signaling is all one; for the case of FDRA type 0 or dynamic switch, a value of a Frequency Domain Resource Assignment field comprised in the first signaling is all 0, or for the case of FDRA type 1, a value of the Frequency Domain Resource Assignment field comprised in the first signaling is all 1.

In one subembodiment of the above five embodiments, the first node is only provided with a downlink semi-continuous scheduling in a scheduled active Downlink/Uplink (DL/UL) BandWidth Part (BWP), or the first node is only provided with an uplink grant type 2 configuration.

In one embodiment, when the following two conditions are satisfied, the first signaling is used to activate the first scheduling, and the two conditions comprise: a format of the first signaling is one of DCI format 0_0, DCI format 0_1, or DCI format 0_2; a value of an RV field comprised in the first signaling is all zero.

In one embodiment, when the following two conditions are satisfied, the first signaling is used to activate the first scheduling, and the two conditions comprise: a format of the first signaling is one of DCI format 1_0 or DCI format 1_2; a value of an RV field comprised in the first signaling is all zero.

In one embodiment, when the following two conditions are satisfied, the first signaling is used to activate the first scheduling, and the two conditions comprise: a format of the first signaling is DCI format 1_1; for an enabled transport block, a value of an RV field comprised in the first signaling is all zero.

In one embodiment, when the following four conditions are satisfied, the first signaling is used to de-activate the first scheduling, and the four conditions comprise: a format of the first signaling is one of DCI format 0_0, DCI format 0_1, or DCI format 0_2; a value of an RV field comprised in the first signaling is all zero; a value of an MCS field comprised in the first signaling is all one; for the case where μ is 1 in type 2 FDRA, a value of a Frequency Domain Resource Assignment field comprised in the first signaling is all zero, or for other cases, a value of the Frequency Domain Resource Assignment field comprised in the first signaling is all one.

In one embodiment, when the following four conditions are satisfied, the first signaling is used to de-activate the first scheduling, and the four conditions comprise: a format of the first signaling is one of DCI format 1_0, DCI format 1_1, or DCI format 1_2; a value of an RV field comprised in the first signaling is all zero; a value of an MCS field comprised in the first signaling is all zero; for the case of FDRA type 0 or dynamic switch, a value of a Frequency Domain Resource Assignment field comprised in the first signaling is all 0, or for the case of FDRA type 1, a value of the Frequency Domain Resource Assignment field comprised in the first signaling is all 1.

In one subembodiment of the above five embodiments, the first node is provided with multiple downlink semi-persistent schedulings in an active DL/UL BWP of a scheduled cell or the first node is provided with multiple uplink grant type 2 configurations.

In one subembodiment of the above five embodiments, a value of the HARQ process number field comprised in the first signaling is used to indicate the first scheduling.

In one embodiment, when a subcarrier spacing (SCS) of frequency-domain resources occupied by the first signaling is 30 KHz, μ is 1.

In one embodiment, when an SCS of frequency-domain resources occupied by a first radio signal is 30 KHz, p, is 1.

In one embodiment, when conditions described in section 10.2 in 3GPP TS38.213 are satisfied, the first signaling is used to activate the first scheduling.

In one embodiment, when conditions described in section 10.2 in 3GPP TS38.213 are satisfied, the first signaling is used to de-activate the first scheduling.

In one embodiment, the first scheduling is executed after being activated and before being de-activated.

In one embodiment, the phrase of the first scheduling being executed after being activated and before being de-activated is: the first scheduling is semi-persistent scheduling.

In one embodiment, the phrase of the first scheduling being executed after being activated and before being de-activated is: the first scheduling is a configured downlink assignment.

In one embodiment, the phrase of the first scheduling being executed after being activated and before being de-activated is: the first scheduling is a configured uplink grant.

In one embodiment, the phrase of the first scheduling being executed after being activated and before being de-activated is: the first scheduling is a Configured Grant Type 2.

In one embodiment, the phrase of the first scheduling being executed after being activated and before being de-activated is: the first scheduling is a dynamic uplink scheduling.

In one embodiment, the first scheduling indicates periodic time-frequency resources.

In one embodiment, the first scheduling indicates a HARQ process number.

In one embodiment, the first scheduling implicitly indicates the HARQ process number.

In one embodiment, the first scheduling indicates an MCS.

In one embodiment, when the first signaling is used to activate the first scheduling, the first signaling and a first RRC signaling are used together to determine the first scheduling.

In one subembodiment of the above embodiment, the first RRC signaling comprises a period of time-domain resources comprised in the periodic time-frequency resources indicated by the first scheduling.

In one subembodiment of the above embodiment, the first signaling comprises frequency-domain resources indicated by the first scheduling and a start position of the time-domain resources comprised in the periodic time-frequency resources indicated by the first scheduling.

In one subembodiment of the above embodiment, the first signaling comprises the MCS indicated by the first scheduling.

In one subembodiment of the above embodiment, the first RRC signaling comprises a HARQ process number indicated by the first scheduling.

In one subembodiment of the above embodiment, the first RRC signaling comprises a HARQ process number offset indicated by the first scheduling.

In one embodiment, the first signaling comprises a first scheduling index, and the first scheduling index is used to indicate the first scheduling; herein, the first node is configured with at least two non-dynamic schedulings.

In one embodiment, time-frequency resources indicated by the first scheduling is used for a multicast transmission.

In one embodiment, time-frequency resources indicated by the first scheduling is used for a unicast transmission.

In one embodiment, after the first scheduling is activated, the first node monitors a radio signal on time-frequency resources indicated by the first scheduling.

In one embodiment, after the first scheduling is de-activated, the first node stops monitoring a radio signal on time-frequency resources indicated by the first scheduling.

In one subembodiment of the above two embodiments, the radio signal is scrambled by the G-CS-RNTI.

In one subembodiment of the above two embodiments, the radio signal is scrambled by the CS-RNTI.

In one embodiment, as a response to receiving the first signaling, a first action is executed, and the first action is related to a current RRC state.

In one embodiment, the current RRC state comprises RRC_CONNECTED State and RRC_INACTIVE State.

In one embodiment, the current RRC state is one of RRC_CONNECTED State or RRC_INACTIVE State.

In one embodiment, when the current RRC state is RRC_IDLE State, the first action is not executed.

In one embodiment, only when the current RRC state is one of RRC_CONNECTED State or RRC_INACTIVE State, the first action is executed.

In one embodiment, for RRC_CONNECTED State and RRC_INACTIVE State, only when the current RRC state is RRC_CONNECTED State, the first action comprises transmitting a first HARQ-ACK on a first time-frequency resource block.

In one embodiment, the first HARQ-ACK is a physical-layer feedback.

In one embodiment, the first HARQ-ACK comprises at least a former of an ACK or a NACK.

In one embodiment, when the first signaling is used to activate the first scheduling, the first HARQ-ACK is an ACK or a NACK.

In one embodiment, when the first signaling is used to activate the first scheduling, the first HARQ-ACK is used to indicate whether a PDSCH scheduled by the first signaling is correctly received.

In one subembodiment of the above embodiment, when the Physical Downlink Shared Channel (PDSCH) scheduled by the first signaling is correctly received, the first HARQ-ACK is an ACK; when the PDSCH scheduled by the first signaling is not correctly received, the first HARQ-ACK is a NACK.

In one embodiment, when the first signaling is used to de-activate the first scheduling, the first HARQ-ACK is an ACK.

In one embodiment, when the first signaling is used to de-activate the first scheduling, the first HARQ-ACK is used to indicate whether the first signaling is correctly received.

In one embodiment, the first time-frequency resource block is used to transmit a Physical Uplink Control Channel (PUCCH).

In one embodiment, time-domain resources comprised in the first time-frequency resource block are indicated by the first signaling.

In one embodiment, frequency-domain resources comprised in the first time-frequency resource block are configured by a PUCCH-config.

In one embodiment, the first HARQ-ACK is multiplexed into a Physical Uplink Shared Channel (PUSCH).

In one embodiment, frequency-domain resources comprised in the first time-frequency resource block are indicated by at least a former of the first signaling and a higher-layer signaling.

In one subembodiment of the above two embodiments, the first signaling indicates frequency-domain resources of the PUSCH and an offset between frequency-domain resources of the first time-frequency resource block and the frequency-domain resources of the PUSCH.

In one subembodiment of the above two embodiments, the first signaling indicates frequency-domain resources of the PUSCH, and the higher-layer signaling indicates an offset between frequency-domain resources of the first time-frequency resource block and the frequency-domain resources of the PUSCH.

In one embodiment, the first time-frequency resource block is only reserved for the first node.

In one embodiment, the first time-frequency resource block is not used by a node other than the first node to transmit a signal.

In one embodiment, the first time-frequency resource block is reserved for a HARQ feedback of a multicast reception.

In one embodiment, the first time-frequency resource block is reserved for a HARQ feedback of a unicast reception.

In one embodiment, the first time-frequency resource block comprises at least one frequency-domain resource and at least one time-domain resource.

In one embodiment, a frequency-domain resource is a subcarrier.

In one embodiment, a frequency-domain resource is a Resource Block (RB), and the RB comprises 12 subcarriers.

In one embodiment, a time-domain resource is a symbol.

In one embodiment, a time-domain resource is a multicarrier symbol.

In one embodiment, a time-domain resource is an Orthogonal Frequency Division Multiplexing (OFDM) symbol.

In one embodiment, a time-domain resource is a slot.

In one embodiment, a time-domain resource is a subframe.

### Embodiment 2

Embodiment 2 illustrates a schematic diagram of a network architecture according to one embodiment of the present application, as shown in FIG. 2. FIG. 2 is a diagram illustrating a network architecture 200 of 5G NR, Long-Term Evolution (LTE), and Long-Term Evolution Advanced (LTE-A) systems. The NR 5G, LTE or LTE-A network architecture 200 may be called a 5G System (5GS)/Evolved Packet System (EPS) 200 or other appropriate terms. The 5GS/EPS 200 may comprise one or more UEs 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). XnAP protocol of Xn interface is used to transmit control plane messages of wireless networks, and user plane protocol of Xn interface is used to transmit user plane data. The gNB 203 may be called a base station, a base transceiver station, a radio base station, a radio transceiver, a transceiver function, a Base Service Set (BSS), an Extended Service Set (ESS), a Transmit-Receive Point (TRP) or some other applicable terms. In NTN network, the gNB 203 may be a satellite, a aircraft or a territorial base station relayed through a satellite. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, vehicle equipment, On-board communication unit, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the gNB 203 corresponds to the second node in the present application.

In one embodiment, the gNB 203 is a Marco Cell base station.

In one embodiment, the gNB 203 is a Micro Cell base station.

In one embodiment, the gNB 203 is a Pico Cell base station.

In one embodiment, the gNB 203 is a Femtocell.

In one embodiment, the gNB 203 is a base station that supports large delay differences.

In one embodiment, the gNB 203 is a flight platform.

In one embodiment, the gNB 203 is satellite equipment.

In one embodiment, the gNB 203 is a test device (e.g., a transceiver device simulating partial functions of a base station, a signaling tester).

In one embodiment, a radio link from the UE 201 to the gNB 203 is an uplink, and the uplink is used to execute an uplink transmission.

In one embodiment, a radio link from the gNB 203 to the UE 201 is a downlink, and the downlink is used to execute a downlink transmission.

In one embodiment, the UE 201 and the gNB 203 are connected via a Uu interface.

### Embodiment 3

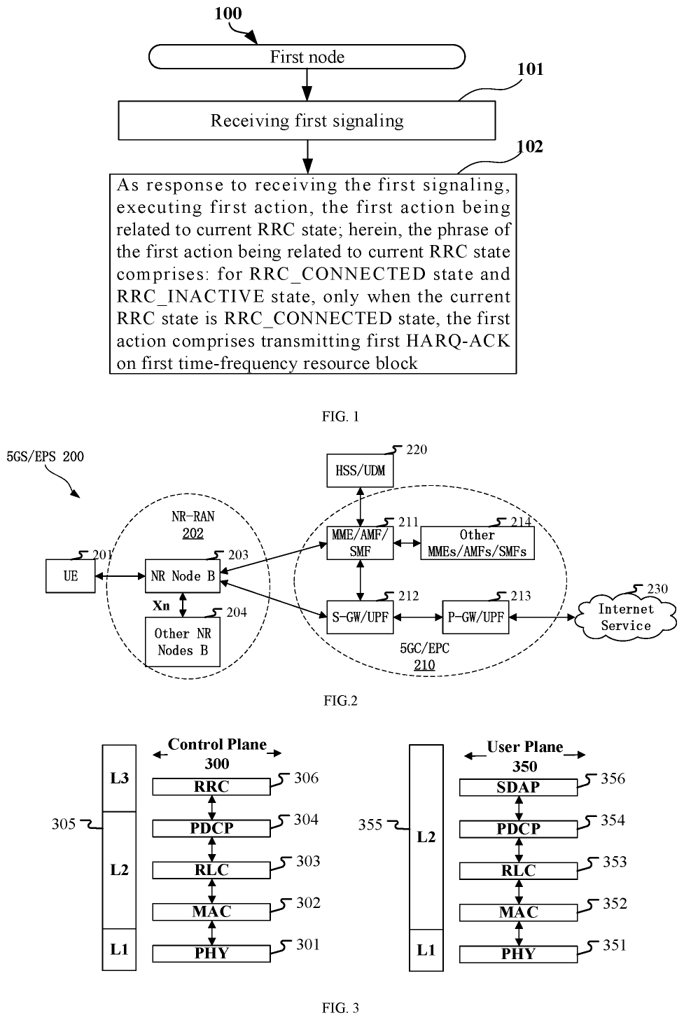

Embodiment 3 illustrates a schematic diagram of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for the control plane 300 of a UE and a gNB is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the UE and the gNB via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the gNBs of the network side. The PDCP sublayer 304 provides data encryption and integrity protection and also provides support for a UE handover between gNBs. The RLC sublayer 303 provides segmentation and reassembling of a packet, retransmission of a lost data packet through ARQ, as well as repeat data packet detection and protocol error detection. The MAC sublayer 302 provides mapping between a logic channel and a transport channel and multiplexing of the logical channel ID. The MAC sublayer 302 is also responsible for allocating between UEs various radio resources (i.e., resources block) in a cell. The MAC sublayer 302 is also responsible for Hybrid Automatic Repeat Request (HARQ) operation. The Radio Resource Control (RRC) sublayer 306 in layer 3 (L3) of the control plane 300 is responsible for acquiring radio resources (i.e., radio bearer) and configuring the lower layer with an RRC signaling between the gNB and the UE. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. The radio protocol architecture of the UE in the user plane 350 may comprises part or all of protocol sublayers of the SDAP sublayer 356, the PDCP sublayer 354, the RLC sublayer 353 and the MAC subalyer 352 at L2 layer. Although not described in FIG. 3, the UE may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, entities of multiple sublayers of the control plane in FIG. 3 form a Signaling Radio Bear (SRB) in the vertical direction.

In one embodiment, entities of multiple sublayers of the user plane in FIG. 3 form a Data Radio Bear (DRB) in the vertical direction.

In one embodiment, entities of multiple sublayers of the user plane in FIG. 3 form an MBS Radio Bearer (MRB) in the vertical direction.

In one embodiment, the first signaling in the present application is generated by the RRC 306.

In one embodiment, the first signaling in the present application is generated by the MAC 302 or the MAC 352.

In one embodiment, the first signaling in the present application is generated by the PHY 301 or the PHY 351.

In one embodiment, the first HARQ-ACK in the present application is generated by the PHY 301 or the PHY 351.

In one embodiment, the first information in the present application is generated by the RRC 306.

In one embodiment, the first information in the present application is generated by the PHY 301 or the PHY 351.

In one embodiment, the first radio signal in the present application is generated by the PHY 301 or the PHY 351.

In one embodiment, the second signaling in the present application is generated by the RRC 306.

In one embodiment, the second signaling in the present application is generated by the MAC 302 or the MAC 352.

In one embodiment, the second signaling in the present application is generated by the PHY 301 or the PHY 351.

In one embodiment, the L2 layer 305 belongs to a higher layer.

In one embodiment, the RRC sublayer 306 in the L3 layer belongs to a higher layer.

### Embodiment 4

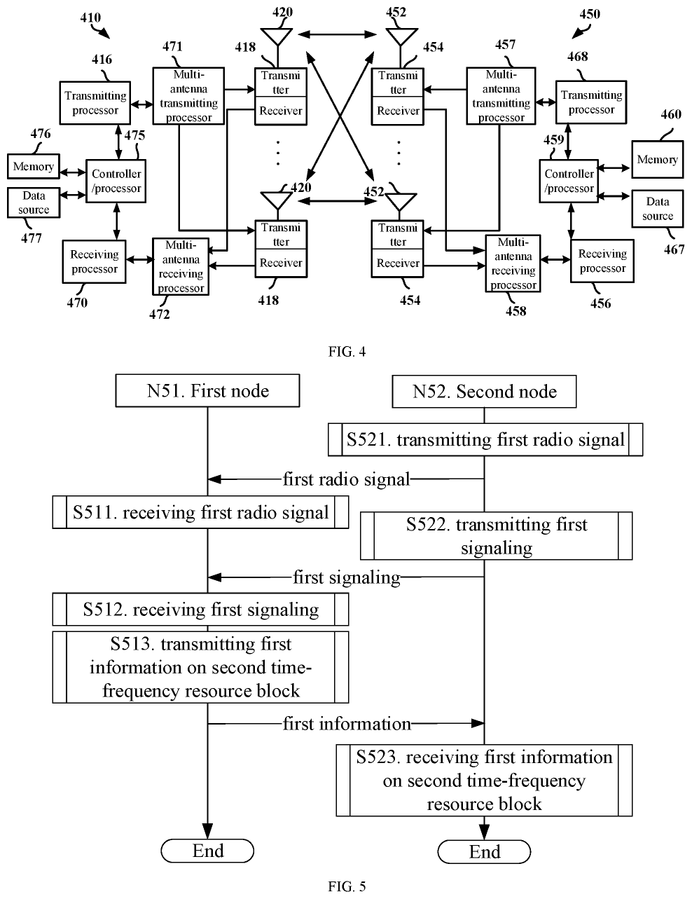

Embodiment 4 illustrates a schematic diagram of hardware modules of a communication device according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a data source 477, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from the core network or a higher layer packet from the data source 477 is provided to the controller/processor 475. The core network and the data source 477 represents all protocol layers above the L2 layer. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In a transmission from the second communication device 410 to the first communication device 450, the controller/processor 459 provides multiplexing between a transport channel and a logical channel, packet reassembling, decryption, header decompression, control signal processing so as to recover a higher-layer packet from the second communication device 410. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the first communication device 450. The higher layer packet from the controller/processor 475 can be provided to all protocol layers above the core network or the L2 layer, and various control signals can also be provided to the core network or L3 layer for L3 layer processing.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first signaling, the first signaling is used to activate a first scheduling, or the first signaling is used to activate a first scheduling; as a response to receiving the first signaling, executes a first action, the first action is related to a current RRC state; herein, the phrase of the first action being related to a current RRC state comprises: for RRC_CONNECTED State and RRC_INACTIVE State, only when the current RRC state is RRC_CONNECTED State, the first action comprises transmitting a first HARQ-ACK on a first time-frequency resource block; the first scheduling is executed after being activated and before being de-activated.

In one embodiment, the first communication device 450 comprises: a memory that stores a computer readable instruction program. The computer readable instruction program generates an action when executed by at least one processor. The action includes: receiving a first signaling, the first signaling being used to activate a first scheduling, or the first signaling being used to de-activate a first scheduling; as a response to receiving the first signaling, executing a first action, the first action being related to a current RRC state; herein, the phrase of the first action being related to a current RRC state comprises: for RRC_CONNECTED State and RRC_INACTIVE State, only when the current RRC state is RRC_CONNECTED State, the first action comprises transmitting a first HARQ-ACK on a first time-frequency resource block; the first scheduling is executed after being activated and before being de-activated.

In one embodiment, the second communication device 410 comprises at least one processor and at least one memory. The at least one memory comprises computer program codes; the at least one memory and the computer program codes are configured to be used in collaboration with the at least one processor, the second communication device 410 at least: transmits a first signaling, the first signaling is used to activate a first scheduling, or the first signaling is used to activate a first scheduling; herein, as a response to receiving the first signaling, a first action is executed, the first action is related to a current RRC state; the phrase of the first action being related to a current RRC state comprises: for RRC_CONNECTED State and RRC_INACTIVE State, only when the current RRC state is RRC_CONNECTED State, the first action comprises transmitting a first HARQ-ACK on a first time-frequency resource block; the first scheduling is executed after being activated and before being de-activated.

In one embodiment, the second communication device 410 comprises a memory that stores a computer readable instruction program. The computer readable instruction program generates an action when executed by at least one processor. The action includes: transmitting a first signaling, the first signaling being used to activate a first scheduling, or the first signaling being used to de-activate a first scheduling; herein, as a response to receiving the first signaling, a first action is executed, the first action is related to a current RRC state; the phrase of the first action being related to a current RRC state comprises: for RRC_CONNECTED State and RRC_INACTIVE State, only when the current RRC state is RRC_CONNECTED State, the first action comprises transmitting a first HARQ-ACK on a first time-frequency resource block; the first scheduling is executed after being activated and before being de-activated.

In one embodiment, the first communication device 450 corresponds to a first node in the present application.

In one embodiment, the second communication device 410 corresponds to a second node in the present application.

In one embodiment, the first communication device 450 is a UE.

In one embodiment, the second communication device 410 is a base station.

In one embodiment, at least one of the antenna 420, the transmitter 418, the multi-antenna transmitting processor 471, the transmitting processor 416 or the controller/processor 475 is used to transmit a first signaling in the present application.

In one embodiment, at least one of the antenna 452, the receiver 454, the multi-antenna receiving processor 458, the receiving processor 456 or the controller/processor 459 is used to receive a first signaling in the present application.

In one embodiment, at least one of the antenna 452, the transmitter 454, the multi-antenna transmitting processor 457, the transmitting processor 468 or the controller/processor 459 is used to transmit a first HARQ-ACK in the present application.

In one embodiment, at least one of the antenna 420, the receiver 418, the multi-antenna receiving processor 472, the receiving processor 470 or the controller/processor 475 is used to receive a first HARQ-ACK in the present application.

In one embodiment, at least one of the antenna 452, the transmitter 454, the multi-antenna transmitting processor 457, the transmitting processor 468 or the controller/processor 459 is used to transmit first information in the present application.

In one embodiment, at least one of the antenna 420, the receiver 418, the multi-antenna receiving processor 472, the receiving processor 470 or the controller/processor 475 is used to receive first information in the present application.

In one embodiment, at least one of the antenna 420, the transmitter 418, the multi-antenna transmitting processor 471, the transmitting processor 416 or the controller/processor 475 is used to transmit a first radio signal in the present application.

In one embodiment, at least one of the antenna 452, the receiver 454, the multi-antenna receiving processor 458, the receiving processor 456 or the controller/processor 459 is used to receive a first radio signal in the present application.

In one embodiment, at least one of the antenna 420, the transmitter 418, the multi-antenna transmitting processor 471, the transmitting processor 416 or the controller/processor 475 is used to transmit a second signaling in the present application.

In one embodiment, at least one of the antenna 452, the receiver 454, the multi-antenna receiving processor 458, the receiving processor 456 or the controller/processor 459 is used to receive a second signaling in the present application.

### Embodiment 5

Embodiment 5 illustrates a flowchart of radio signal transmission according to one embodiment in the present application, as shown in FIG. 5. A first node and a second node are in communications via an air interface. It is particularly underlined that the order illustrated in the embodiment does not put constraints over sequences of signal transmissions and implementations.

The first node N51 receives a first radio signal in step S511; receives a first signaling in step S512; transmits first information on a second time-frequency resource block in step S513.

The second node N52 transmits a first radio signal in step S521; transmits a first signaling in step S522; receives first information on a second time-frequency resource block in step S523.

In embodiment 5, a first signaling is received, the first signaling is used to activate a first scheduling, or the first signaling is used to activate a first scheduling; and a first processor, as a response to receiving the first signaling, executes a first action, the first action is related to a current RRC state; herein, the phrase of the first action being related to a current RRC state comprises: for RRC_CONNECTED State and RRC_INACTIVE State, only when the current RRC state is RRC_CONNECTED State, the first action comprises transmitting a first HARQ-ACK on a first time-frequency resource block; the first scheduling is executed after being activated and before being de-activated; when the current RRC state is RRC_INACTIVE State, the first action comprises transmitting first information on a second time-frequency resource block, there at least exists one RE not belonging to the first time-frequency resource block and a second time-frequency resource block at the same time; the first information is a HARQ-ACK; a transmission channel occupied by the first information comprises a UL-SCH; receiving a first radio signal, the first scheduling being used to determine configuration information of the first radio signal, the configuration information comprises at least one of occupied frequency-domain resources, occupied time-domain resources, an MCS or a HARQ process number; a NACK-only uplink feedback is executed for the first radio signal.

In one embodiment, when a time for receiving the first radio signal is earlier than a time for receiving the first signaling, the first signaling is used to de-activate the first scheduling.

In one embodiment, when a time for receiving the first radio signal is not earlier than a time for receiving the first signaling, the first signaling is used to de-activate the first scheduling.

It should be noted that in FIG. 5, only a reception of a first radio signal is earlier than a reception of the first signaling, that is, the first signaling is used to de-activate the scenario of a first scheduling; FIG. 5 does not show that a reception of a first radio signal is not earlier than a reception of the first signaling, that is, the first signaling is used to activate scenario of the first scheduling.

In one embodiment, the second node is a base station of a serving cell of the first node.

In one embodiment, the second node is a base station of a primary cell of the first node.

In one embodiment, the second node is a base station of a secondary cell of the first node.

In one embodiment, the second node is a base station of a camping cell of the first node.

In one embodiment, time-frequency resources occupied by the first radio signal are a time-frequency resource in the periodic time-frequency resources indicated by the first scheduling.

In one embodiment, an MCS of the first radio signal is the MCS indicated by the first scheduling.

In one embodiment, the first radio signal is transmitted through a PDSCH.

In one embodiment, the first radio signal is scrambled by the G-CS-RNTI.

In one embodiment, a target receiver of the first radio signal comprises at least one node other than the first node.

In one embodiment, the first radio signal is used to carry data belonging to a multicast MBS Radio Bearer (MRB).

In one embodiment, the first radio signal is scrambled by the CS-RNTI.

In one embodiment, the first radio signal is used to carry data belonging to a Data Radio Bearer (DRB).

In one embodiment, the first scheduling is used to determine configuration information of a first-type radio signal, and the first radio signal belongs to the first-type radio signal.

In one embodiment, the first scheduling is used to determine configuration information of the first radio signal, and the configuration information comprises at least one of occupied frequency-domain resources, occupied time-domain resources, an MCS, or a HARQ process number of the first radio signal.

In one embodiment, the HARQ process number indicated by the first scheduling and time-domain resources occupied the first radio signal are used together to determine the HARQ process number of the first radio signal.

In one embodiment, the HARQ process number of the first radio signal HARQ Process ID=[floor (CURRENT_slot×10/(numberOfSlotsPerFrame X periodicity))] modulo nrofHARQ-Processes; herein, the CURRENT_slot=[(SFN X numberOfSlotsPerFrame)+ slot number in the frame], the System Frame Number (SFN) is a system frame number where a start slot of a transmission of the first radio signal is located, the numberOfSlotsPerFrame is a number of continuous slots comprised per frame, the slot number in the frame is a slot number of a start slot of a transmission of the first radio signal in a frame, the periodicity is a period of time-domain resources comprised in the time-frequency resources indicated by the first scheduling; the nrofHARQ-Processes is the HARQ process number indicated by the first scheduling; the floor (·) is a downward rounding operation; the modulo is modulo operation.

In one embodiment, the HARQ process number indicated by the first scheduling, the HARQ process number offset indicated by the first scheduling and time-domain resources occupied the first radio signal are used together to determine the HARQ process number of the first radio signal.

In one embodiment, the HARQ process number of the first radio signal HARQ Process ID=[floor (CURRENT_slot×10/(numberOfSlotsPerFrame X periodicity))] modulo nrofHARQ-Processes+harq-ProcID-Offset; herein, the CURRENT_slot=[(SFN X numberOfSlotsPerFrame)+slot number in the frame], the SFN is a system fame number where a start slot of a transmission of the first radio signal is located, the numberOfSlotsPerFrame is a number of continuous slot(s) per frame, the slot number in the frame is a slot number of a start slot of a transmission of the first radio signal in a frame; the periodicity is a period of time-domain resources comprised in the time-frequency resources indicated by the first scheduling; the nrofHARQ-Processes is the HARQ process number indicated by the first scheduling; the harq-ProclD-Offset is the HARQ process number offset indicated by the first scheduling; the floor( )is the downward rounding operation; the modulo is modulo operation.

In one embodiment, a NACK-only uplink feedback is executed for the first radio signal.

In one embodiment, the phrase of a NACK-only uplink feedback being executed for the first radio signal comprises: only when the first radio signal is not successfully decoded, an uplink feedback is executed; herein, in a PUCCH slot, there only exists a NACK-only uplink feedback for the first radio signal.

In one embodiment, the phrase of a NACK-only uplink feedback being executed for the first radio signal comprises: in a same PUCCH slot, when there is at least one NACK-only uplink feedback for other radio signals in addition to a NACK-only uplink feedback for the first radio signal, multiple HARQ-ACK bits are multiplexed by switching NACK-only to ACK/NACK HARQ bits.

In one embodiment, frequency-domain resources occupied by the NACK are configured by PUCCH-config.

In one embodiment, time-domain resources occupied by the NACK are indicated by the first scheduling.

In one embodiment, when the first signaling is used to activate the first scheduling, the first signaling comprises a time interval between time-domain resources for transmitting a NACK-only uplink feedback and time-domain resources occupied by the first radio signal.

In one embodiment, when the first signaling is used to activate the first scheduling, the first signaling comprises a time interval between a start time of time-domain resources for transmitting a NACK-only uplink feedback and an end time of time-domain resources occupied by the first radio signal.

In one embodiment, time-frequency resources occupied by the NACK are reserved for multiple nodes comprising the first node.

In one embodiment, a time-frequency resource block occupied by the NACK is reserved for a HARQ feedback of a multicast reception.

In one embodiment, when the current RRC state is RRC_INACTIVE State, the first action comprises transmitting first information on a second time-frequency resource block.

In one subembodiment of the above embodiment, before executing the first action, a cell reselection does not occur in the first node.

In one embodiment, the second time-frequency resource block comprises at least one frequency-domain resource and at least one time-domain resource.

In one embodiment, there at least exists an RE not belonging to the first time-frequency resource block and a second time-frequency resource block.

In one subembodiment of the above embodiment, frequency-domain resources comprised in the second time-frequency resource block and frequency-domain resources comprised in the first time-frequency resource block are orthogonal.

In one subembodiment of the above embodiment, frequency-domain resources comprised in the second time-frequency resource block and frequency-domain resources comprised in the first time-frequency resource block are partially overlapping.

In one subembodiment of the above embodiment, time-domain resources comprised in the second time-frequency resource block and time-domain resources comprised in the first time-frequency resource block are orthogonal.

In one subembodiment of the above embodiment, time-domain resources comprised in the second time-frequency resource block and time-domain resources comprised in the first time-frequency resource block are partially overlapping.

In one embodiment, an RE is a time-frequency resource, an RE comprises a symbol in time domain, and comprises a subcarrier in frequency domain.

In one embodiment, the first information is physical-layer information.

In one embodiment, the first information is a HARQ-ACK.

In one embodiment, the first information comprises at least a former of an ACK or a NACK.

In one embodiment, when the first signaling is used to activate the first scheduling, the first information is an ACK or a NACK.

In one embodiment, when the first signaling is used to activate the first scheduling, the first information is used to indicate whether a PDSCH scheduled by the first signaling is correctly received.

In one embodiment, when the first signaling is used to de-activate the first scheduling, the first information is an ACK.

In one embodiment, when the first signaling is used to de-activate the first scheduling, the first information is used to indicate whether the first signaling is correctly received.

In one embodiment, when the first information is a HARQ-ACK, the second time-frequency resource block is reserved for a PUCCH.

In one subembodiment of the above embodiment, frequency-domain resources comprised in the second time-frequency resource block are configured by PUCCH-config.

In one subembodimet of the above embodiment, time-domain resources comprised in the second time-frequency resource block are indicated by the first signaling.

In one subembodiment of the above embodiment, the second time-frequency resource block is only reserved for the first node.

In one subembodiment of the above embodiment, the second time-frequency resource is not used by a node other than the first node for transmitting a signal.

In one subembodiment of the above embodiment, the second time-frequency resource block is only reserved a HARQ feedback of a multicast reception.

In one embodiment, the first receiver, receives a second RRC signaling, and the second RRC signaling indicates the frequency-domain resources comprised in the second time-frequency resource block; herein, the first information is a HARQ-ACK.

In one embodiment, the second RRC signaling is an RRCRelease, and the second RRC signaling indicates that the first node enters into RRC_INACTIVE State.

In one embodiment, the second RRC signaling is an RRCReconfiguration.

In one embodiment, the first action comprises transmitting first information on a second time-frequency resource block; herein, the second time-frequency resource block is reserved for a feedback for a unicast reception, and the first information is a HARQ-ACK; the first node is in a small data transmission (SDT) procedure.

In one subembodiment of the above embodiment, the first node is not configured with HARQ feedback resources for a multicast reception.

In one embodiment, before transmitting the first information, judge whether the first node is in uplink synchronization state, when the first node is not in uplink synchronization state, the first node acquires uplink synchronization through random access procedure before transmitting the first information.

In one embodiment, a transmitter of the second RRC signaling and a transmitter of the first signaling are co-located.

In one embodiment, a transmitter of the second RRC signaling and a transmitter of the first signaling are a same node.

In one embodiment, a transport channel occupied by the first information comprises an Uplink Shared Channel (UL-SCH).

In one subembodiment of the above embodiment, the first signaling is used to de-activate the first scheduling.

In one embodiment, the first information is a higher-layer signaling.

In one embodiment, the first information is an RRC signaling.

In one embodiment, the first information is one of RRCResumeRequest or RRCResumeRequestl.

In one embodiment, the first information is used to request resuming an RRC connection.

In one embodiment, the first information is comprised in Msg3 in a random access procedure triggered by the first node; herein, the random access procedure is 4-step random access procedure, and the second time-frequency resource block is indicated by a Random Access Response (RAR) of the random access procedure.

In one embodiment, the first information is comprised in MsgA in a random access procedure triggered by the first node; herein, the random access procedure is 2-step random access procedure, and the second time-frequency resource block is associated with a Physical Random Access CHannel (PRACH) of the random access procedure.

In one embodiment, the second time-frequency resource block is used to transmit a PUSCH.

In one embodiment, a logical channel occupied by the first information comprises a Common Control Channel (CCCH).

### Embodiment 6

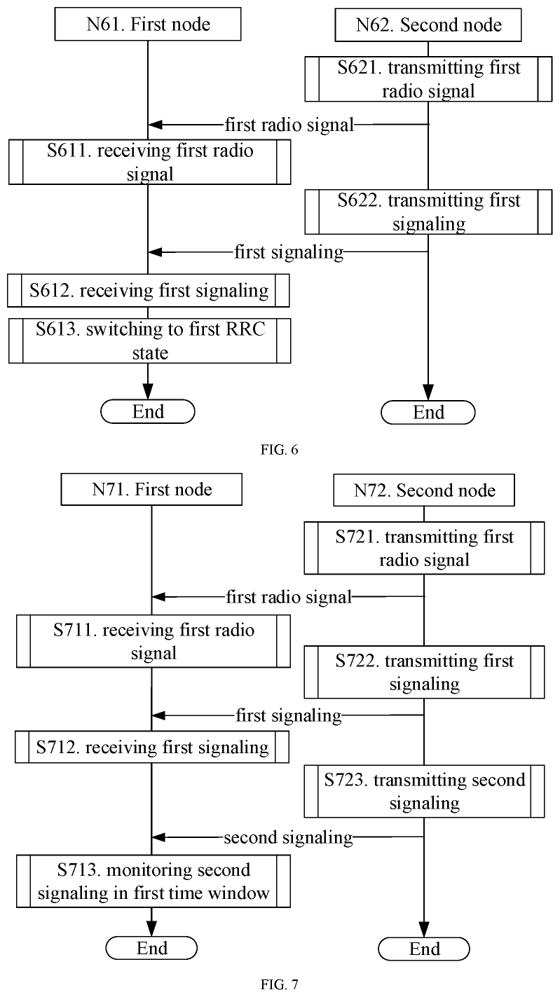

Embodiment 6 illustrates another flowchart of radio signal transmission according to one embodiment in the present application, as shown in FIG. 6. A first node and a second node are in communications via an air interface. It is particularly underlined that the order illustrated in the embodiment does not put constraints over sequences of signal transmissions and implementations.

The first node N61 receives a first radio signal in step S611; receives a first signaling in step S612; switches to a first RRC state in step S613.

The second node N62 transmits a first radio signal in step S621; transmits a first signaling in step S622.

In embodiment 6, a first signaling is received, the first signaling is used to activate a first scheduling, or the first signaling is used to de-activate a first scheduling; and a first processor, as a response to receiving the first signaling, executes a first action, the first action is related to a current RRC state; herein, the phrase of the first action being related to a current RRC state comprises: for RRC_CONNECTED State and RRC_INACTIVE State, only when the current RRC state is RRC_CONNECTED State, the first action comprises transmitting a first HARQ-ACK on a first time-frequency resource block; the first scheduling is executed after being activated and before being de-activated; when the current RRC state is RRC_INACTIVE State, the first action comprises switching to a first RRC state; herein, the first signaling is used to de-activate the first scheduling; the first RRC state is one of RRC_INACTIVE State or RRC_IDLE State.

In one embodiment, when the current RRC state is RRC_INACTIVE State, the first action comprises switching to a first RRC state; herein, the first signaling is used to de-activate the first scheduling; the first RRC state is one of RRC_INACTIVE State or RRC_IDLE State.

In one embodiment, the phrase of switching to a first RRC state comprises: switching from RRC_INACTIVE State to RRC_IDLE State.

In one embodiment, the phrase of switching to a first RRC state comprises maintaining RRC_INACTIVE State.

In one embodiment, when the current RRC state is RRC_INACTIVE State and the first signaling is used to de-activate the first scheduling, the first RRC state is determined according to whether the first node stores other schedulings and whether the first node has an un-suspended first-type radio bearer.

In one embodiment, when the current RRC state is RRC_INACTIVE State, the first action comprises switching from the RRC_INACTIVE State to RRC_IDLE state; herein, the first signaling is used to de-activate the first scheduling; after the first scheduling is de-activated, the first node does not store other schdulings and there is no un-suspended first-type radio bearer.

In one embodiment, when the current RRC state is RRC_INACTIVE State, the first action comprises maintaining the RRC_INACTIVE State; herein, the first signaling is used to de-activate the first scheduling; after the first scheduling is de-activated, the first node also stores other schedulings.

In one embodiment, when the current RRC state is RRC_INACTIVE State, the first action comprises maintaining the RRC_INACTIVE State; herein, the first signaling is used to de-activate the first scheduling; after the first scheduling is de-activated, the first node at least has one first-type radio bearer not being suspended.

In one embodiment, the other schedulings are configured downlink assignments.

In one embodiment, the other schedulings are configured uplink grants.

In one embodiment, the phrase of there being no unsuspended first-type radio bearer comprises: all the first-type radio bearers are suspended.

In one embodiment, when a radio bearer is established, the radio bearer can be suspended or not suspended.

In one embodiment, a radio bearer being suspended or not being suspended are for an established radio bearer instead of a released radio bearer.

In one embodiment, a radio bearer being suspended comprises: a radio bearer being established but not being used for data transmission.

In one embodiment, a radio bearer being suspended comprises: a radio bearer not being released and not being used for data transmission.

In one embodiment, when a radio bearer is suspended, a PDCP associated with the radio bearer being suspended is indicated to a lower layer of the radio bearer.

In one embodiment, when a radio bearer is suspended, a PDCP of the radio bearer is not released.

In one embodiment, when a radio bearer is suspended, a radio bearer identifier of the radio bearer is not released.

In one embodiment, a radio bearer not being suspended comprises: a radio bearer being in an activated state.

In one embodiment, a radio bearer not being suspended comprises: a radio bearer being resumed.

In one embodiment, a radio bearer not being suspended comprises: a radio bearer being established and being used for data transmission.

In one embodiment, a radio bearer not being suspended comprises: a radio bearer not being released and being used for data transmission.

In one embodiment, the first-type radio bearer is used for data transmission under the RRC_INACTIVE State.

In one embodiment, the first-type radio bearer comprises a multicast MRB.

In one embodiment, the first-type radio bearer comprises a multicast MRB for transmitting an MBS interested by the first node.

In one embodiment, the first-type radio bearer comprises a DRB.

In one embodiment, the first-type radio bearer comprises a Signaling Radio Bearer 2 (SRB2).

### Embodiment 7

Embodiment 7 illustrates a third flowchart of radio signal transmission according to one embodiment of the present application, as shown in FIG. 7. A first node and a second node are in communications via an air interface. It is particularly underlined that the order illustrated in the embodiment does not put constraints over sequences of signal transmissions and implementations.

The first node N71 receives a first radio signal in step S711; receives a first signaling in step S712; monitors a second signaling in a first time window in step S713.

The second node N72 transmits a first radio signal in step S721; transmits a first signaling in step S722; and transmits a second signaling in step S723.

In embodiment 7, a first signaling is received, the first signaling is used to activate a first scheduling, or the first signaling is used to de-activate a first scheduling; and a first processor, as a response to receiving the first signaling, executes a first action, the first action is related to a current RRC state; herein, the phrase of the first action being related to a current RRC state comprises: for RRC_CONNECTED State and RRC_INACTIVE State, only when the current RRC state is RRC_CONNECTED State, the first action comprises transmitting a first HARQ-ACK on a first time-frequency resource block; the first scheduling is executed after being activated and before being de-activated; when the current RRC state is RRC_INACTIVE State, the first action comprises monitoring a second signaling in a first time window; herein, the first signaling is used to de-activate the first scheduling; the second signaling is scheduled by a PDCCH addressed to a unicast RNTI.

In one embodiment, when the current RRC state is RRC_INACTIVE State, the first action comprises monitoring a second signaling in a first time window; herein, the first signaling is used to de-activate the first scheduling.

In one subembodiment of the above embodiment, the first node is not in an SDT procedure.

In one embodiment, a start time of the first time window is an end time of time-domain resources occupied by the first signaling.

In one embodiment, a time interval between a start time of the first time window and an end time for receiving the first signaling is not less than Q time unit(s), Q being a positive integer not less than 1.

In one embodiment, the time unit is represented by symbol.

In one embodiment, the time unit is represented by slot.

In one embodiment, the time unit is represented by subframe.

In one embodiment, a time length of the first time window is configured by network.

In one embodiment, the time length of the first time window is pre-configured.

In one embodiment, the time length of the first time window is specific.

In one embodiment, the time length of the first time window is variable.

In one embodiment, when the second signaling is received, the first time window is ended.

In one embodiment, the time length of the first time window remains unchanged.

In one embodiment, when the second signaling is received, stop continuing monitoring in the first time window.

In one embodiment, when the first time window is expired, switch from RRC_INACTIVE State to RRC_IDLE State.

In one embodiment, when the first time window is expired, maintain RRC_INACTIVE State.

In one embodiment, the second signaling is scheduled by a PDCCH addressed to a unicast RNTI.

In one embodiment, the meaning of monitoring a second signaling comprises: monitoring whether there exists a PDCCH addressed to a unicast RNTI, and the PDCCH schedules a transmission of the second signaling.

In one embodiment, the unicast RNTI is used to identify the first node in RRC_INACTIVE State.

In one embodiment, the unicast RNTI is a Cell-RNTI (C-RNTI), and the second RRC signaling indicates that the first node does not release the C-RNTI.

In one embodiment, the second RRC signaling indicates the unicast RNTI.

In one embodiment, when the second RRC signaling indicates that at least one multicast MRB is not suspended, the second RRC signaling indicates the unicast RNTI.

In one embodiment, a PDCCH addressed to the unicast RNTI is monitored only in the first time window.

In one embodiment, whether there exists the PDCCH is determined through energy monitoring.

In one embodiment, whether there exists the PDCCH is determined through a maximum likelihood detection.

In one embodiment, whether there exists the PDCCH is determined through a blindly decoding detection.

In one embodiment, whether there exists the PDCCH is determined through a coherent detection.

In one embodiment, the second signaling is an RRC signaling.

In one embodiment, the second signaling is used to indicate entering into RRC_INACTIVE State.

In one embodiment, the second signaling is used to release an RRC connection.

In one embodiment, the second signaling is an RRCRelease.

In one embodiment, the second signaling is an RRCRelease comprising a suspendConfig field.

In one embodiment, the second signaling is a MAC CE.

In one embodiment, the second signaling is a DCI.

In one embodiment, the second signaling is a PDCCH addressed to the unicast RNTI.

### Embodiment 8

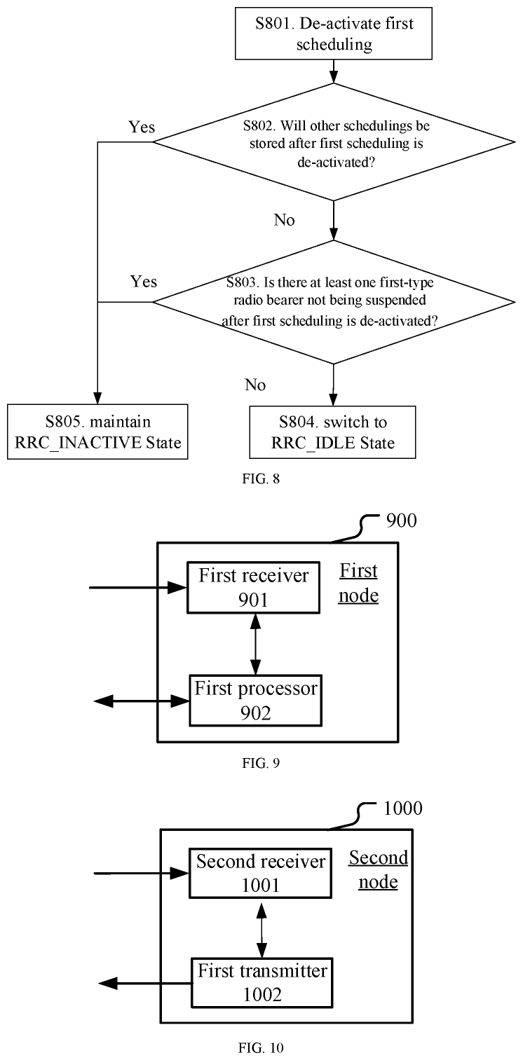

Embodiment 8 illustrates a schematic diagram of switching to a first RRC state according to one embodiment of the present application, as shown in FIG. 8.

In embodiment 8, de-activate a first scheduling in step S801; in step S802, judge whether other schedulings are stored after a first scheduling is deactivated, if yes, execute step S805; if no, execute step S803; in step S803, judge whether there exists at least one first-type radio bearer not being suspended after a first scheduling is de-activated, if yes, execute step S805, if no, execute step S804; switch to RRC_IDLE State in step S804; maintain RRC_INACTIVE State in step S805.

In embodiment 8, the first signaling is received in RRC_INACTIVE State, and the first signaling is used to de-activate the first scheduling.

In one embodiment, after the first scheduling is de-activated, the first node does not store the other schedulings, and when there is no unsuspended first-type radio bearer, switches from RRC_INACTIVE State to RRC_IDLE State.

In one embodiment, after the first scheduling is de-activated, the first node also stores the other schedulings, or, when there exists at least one unsuspended first-type radio bearer, maintains RRC_INACTIVE State.

### Embodiment 9

Embodiment 9 illustrates a structure block diagram of a processor of a first node, as shown in FIG. 9. In FIG. 9, a processor of a first node 900 comprises a first receiver 901 and a first processor 902; the first node 900 is a UE.

In embodiment 9, the first receiver 901 receives a first signaling, the first signaling is used to activate a first scheduling, or the first signaling is used to activate a first scheduling; and the first processor 902, as a response to receiving the first signaling, executes a first action, the first action is related to a current RRC state; herein, the phrase of the first action being related to a current RRC state comprises: for RRC_CONNECTED State and RRC_INACTIVE State, only when the current RRC state is RRCCONNECTED State, the first action comprises transmitting a first HARQ-ACK on a first time-frequency resource block; the first scheduling is executed after being activated and before being de-activated.

In one embodiment, when the current RRC state is RRC_INACTIVE State, the first action comprises transmitting first information on a second time-frequency resource block, there at least exists one RE not belonging to the first time-frequency resource block and a second time-frequency resource block at the same time.

In one embodiment, when the current RRC state is RRC_INACTIVE State, the first action comprises transmitting first information on a second time-frequency resource block, there at least exists one RE not belonging to the first time-frequency resource block and a second time-frequency resource block at the same time; the first information is a HARQ-ACK.

In one embodiment, when the current RRC state is RRC_INACTIVE State, the first action comprises transmitting first information on a second time-frequency resource block, there at least exists one RE not belonging to the first time-frequency resource block and a second time-frequency resource block at the same time; a transmission channel occupied by the first information comprises a UL-SCH.

In one embodiment, when the current RRC state is RRC_INACTIVE State, the first action comprises switching to a first RRC state; herein, the first signaling is used to de-activate the first scheduling; the first RRC state is one of RRC_INACTIVE State or RRC_IDLE State.

In one embodiment, when the current RRC state is RRC_INACTIVE State, the first action comprises monitoring a second signaling in a first time window; herein, the first signaling is used to de-activate the first scheduling; the second signaling is scheduled by a PDCCH addressed to a unicast RNTI.

In one embodiment, the first receiver 901, receives a first radio signal, the first scheduling is used to determine configuration information of the first radio signal, the configuration information comprises at least one of occupied frequency-domain resources, occupied time-domain resources, an MCS or a HARQ process number; the first processor 902, executes a NACK-only uplink feedback for the first radio signal.

In one embodiment, the first receiver 901 comprises the receiver 454 (comprising the antenna 452), the receiving processor 456, the multi-antenna receiving processor 458 and the controller/processor 459 in FIG. 4 of the present application.

In one embodiment, the first receiver 901 comprises at least one of the receiver 454 (comprising the antenna 452), the receiving processor 456, the multi-antenna receiving processor 458 or the controller/processor 459 in FIG. 4 of the present application.

In one embodiment, the first processor 902 comprises the receiver 454 (comprising the antenna 452), the receiving processor 456, the multi-antenna receiving processor 458 and the controller/processor 459 in FIG. 4 of the present application.

In one embodiment, the first processor 902 comprises at least one of the receiver 454 (comprising the antenna 452), the receiving processor 456, the multi-antenna receiving processor 458 or the controller/processor 459 in FIG. 4 of the present application.

In one embodiment, the first processor 902 comprises the transmitter 454 (comprising the antenna 452), the transmitting processor 468, the multi-antenna transmitting processor 457 and the controller/processor 459 in FIG. 4 of the present application.

In one embodiment, the first processor 902 comprises at least one of the transmitter 454 (comprising the antenna 452), the transmitting processor 468, the multi-antenna transmitting processor 457 or the controller/processor 459 in FIG. 4 of the present application.

In one embodiment, the first processor 902 comprises the controller/processor 459 in FIG. 4 of the present application.

### Embodiment 10

Embodiment 10 illustrates a structure block diagram of a processor in a second node according to one embodiment of the present application, as shown in FIG. 10. In FIG. 10, a processor in a second node 1000 comprises a second receiver 1001 and a first transmitter 1002; the second node 1000 is a base station.

In embodiment 10, the first transmitter 1002, transmits a first signaling, the first signaling is used to activate a first scheduling, or the first signaling is used to deactivate a first scheduling; herein, as a response to receiving the first signaling, a first action is executed, the first action is related to a current RRC state; the phrase of the first action being related to a current RRC state comprises: for RRC_CONNECTED State and RRC_INACTIVE State, only when the current RRC state is RRC_CONNECTED State, the first action comprises transmitting a first HARQ-ACK on a first time-frequency resource block; the first scheduling is executed after being activated and before being de-activated.

In one embodiment, when the current RRC state is RRC_INACTIVE State, the first action comprises transmitting first information on a second time-frequency resource block, there at least exists one RE not belonging to the first time-frequency resource block and a second time-frequency resource block at the same time.

In one embodiment, when the current RRC state is RRC_INACTIVE State, the first action comprises transmitting first information on a second time-frequency resource block, there at least exists one RE not belonging to the first time-frequency resource block and a second time-frequency resource block at the same time; the first information is a HARQ-ACK.

In one embodiment, when the current RRC state is RRC_INACTIVE State, the first action comprises transmitting first information on a second time-frequency resource block, there at least exists one RE not belonging to the first time-frequency resource block and a second time-frequency resource block at the same time; a transmission channel occupied by the first information comprises a UL-SCH.

In one embodiment, when the current RRC state is RRC_INACTIVE State, the first action comprises switching to a first RRC state; herein, the first signaling is used to de-activate the first scheduling; the first RRC state is one of RRC_INACTIVE State or RRC_IDLE State.

In one embodiment, when the current RRC state is RRC_INACTIVE State, the first action comprises monitoring a second signaling in a first time window; herein, the first signaling is used to de-activate the first scheduling; the second signaling is scheduled by a PDCCH addressed to a unicast RNTI.

In one embodiment, the first transmitter 1002, transmits a first radio signal, the first scheduling is used to determine configuration information of the first radio signal, the configuration information comprises at least one of occupied frequency-domain resources, occupied time-domain resources, an MCS or a HARQ process number; the second receiver 1001, receives a NACK-only uplink feedback for the first radio signal.

In one embodiment, the second receiver 1001 comprises the receiver 418 (comprising the antenna 420), the receiving processor 470, the multi-antenna receiving processor 472 and the controller/processor 475 in FIG. 4 in the present application.

In one embodiment, the second receiver 1001 comprises at least one of the receiver 418 (comprising the antenna 420), the receiving processor 470, the multi-antenna receiving processor 472 or the controller/processor 475 in FIG. 4 in the present application.

In one embodiment, the first transmitter 1002 comprises the transmitter 418 (including the antenna 420), the transmitting processor 416, the multi-antenna transmitting processor 471 and controller/processor 475 in FIG. 4 of the present application.

In one embodiment, the first transmitter 1002 comprises at least one of the transmitter 418 (including the antenna 420), the transmitting processor 416, the multi-antenna transmitting processor 471 or the controller/processor 475 in FIG. 4 of the present application.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. A first-type communication node or a UE or a terminal in the present application includes but not limited to mobile phones, tablet computers, laptops, network cards, low-power devices, enhanced Machine Type Communication (eMTC) devices, NB-IOT devices, vehicle-mounted communication equipments, aircrafts, airplanes, unmanned aerial vehicles (UAV), telecontrolled aircrafts and other wireless communication devices. The second-type communication node or the base station or the network side device in the present application includes but is not limited to the macro-cellular base stations, micro-cellular base stations, home base stations, relay base stations, eNBs, gNBs, Transmission and Reception Points (TRP), relay satellites, satellite base stations, air base stations, test equipment, such as a transceiver that simulates partial functions of the base station, signaling testers_and other wireless communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling being used to activate a first scheduling, or the first signaling being used to de-activate a first scheduling; and
a first processor, as a response to receiving the first signaling, executing a first action, the first action being related to a current Radio Resource Control (RRC) state;
wherein the phrase of the first action being related to a current RRC state comprises: for RRC_CONNECTED State and RRC_INACTIVE State, only when the current RRC state is RRC_CONNECTED State, the first action comprises transmitting a first Hybrid Automatic Repeat Request-ACKnowledgement (HARQ-ACK) on a first time-frequency resource block; the first scheduling is executed after being activated and before being de-activated.

2. The first node according to claim 1, wherein when the current RRC state is RRC_INACTIVE State, the first action comprises transmitting first information on a second time-frequency resource block, there at least exists one RE not belonging to the first time-frequency resource block and a second time-frequency resource block at the same time.

3. The first node according to claim 2, wherein the first information is a HARQ-ACK.

4. The first node according to claim 2, wherein a transport channel occupied by the first information comprises an Uplink Shared Channel (UL-SCH).

5. The first node according to claim 1, wherein when the current RRC state is RRC_INACTIVE State, the first action comprises switching to a first RRC state;
wherein the first signaling is used to de-activate the first scheduling; the first RRC state is one of RRC_INACTIVE State or RRC_IDLE State.

6. The first node according to claim 1, wherein when the current RRC state is RRC_INACTIVE State, the first action comprises monitoring a second signaling in a first time window;
wherein the first signaling is used to de-activate the first scheduling; the second signaling is scheduled by a Physical Downlink Control Channel (PDCCH) addressed to a unicast Radio Network Temporary Identifier (RNTI).

7. The first node according to claim 1, comprising:
the first receiver, receiving a first radio signal, the first scheduling being used to determine configuration information of the first radio signal, the configuration information comprises at least one of occupied frequency-domain resources, occupied time-domain resources, a Modulation and coding scheme (MCS) or a HARQ process number;
the first processor, executeing a Negative ACKnowledgment (NACK)-only uplink feedback for the first radio signal.

8. A second node for wireless communications, comprising:
a first transmitter, transmitting a first signaling, the first signaling being used to activate a first scheduling, or the first signaling being used to de-activate a first scheduling;
wherein as a response to receiving the first signaling, a first action is executed, the first action is related to a current RRC state; the phrase of the first action being related to a current RRC state comprises: for RRC_CONNECTED State and RRC_INACTIVE State, only when the current RRC state is RRC_CONNECTED State, the first action comprises transmitting a first HARQ-ACK on a first time-frequency resource block; the first scheduling is executed after being activated and before being de-activated.

9. The second node according to claim 8, wherein when the current RRC state is RRC_INACTIVE State, the first action comprises transmitting first information on a second time-frequency resource block, there at least exists one RE not belonging to the first time-frequency resource block and a second time-frequency resource block at the same time.

10. The second node according to claim 9, wherein the first information is a HARQ-ACK.

11. The second node according to claim 9, wherein a transport channel occupied by the first information comprises a UL-SCH.

12. The second node according to claim 8, wherein when the current RRC state is RRC_INACTIVE State, the first action comprises switching to a first RRC state;
wherein the first signaling is used to de-activate the first scheduling; the first RRC state is one of RRC_INACTIVE State or RRC_IDLE State.

13. The second node according to claim 8, wherein when the current RRC state is RRC_INACTIVE State, the first action comprises monitoring a second signaling in a first time window;
wherein the first signaling is used to de-activate the first scheduling; the second signaling is scheduled by a PDCCH addressed to a unicast RNTI.

14. The second node according to claim 8, comprising:
the first transmitter, transmitting a first radio signal, the first scheduling being used to determine configuration information of the first radio signal, the configuration information comprising at least one of occupied frequency-domain resources, occupied time-domain resources, an MCS or a HARQ process number;
the second receiver, receiving a NACK-only uplink feedback for the first radio signal.

15. A method in a first node for wireless communications, comprising:
receiving a first signaling, the first signaling being used to activate a first scheduling, or the first signaling being used to de-activate a first scheduling; and
as a response to receiving the first signaling, executing a first action, the first action being related to a current RRC state;
wherein the phrase of the first action being related to a current RRC state comprises: for RRC_CONNECTED State and RRC_INACTIVE State, only when the current RRC state is RRC_CONNECTED State, the first action comprises transmitting a first HARQ-ACK on a first time-frequency resource block; the first scheduling is executed after being activated and before being de-activated.

16. The method in a first node according to claim 15, wherein when the current RRC state is RRC_INACTIVE State, the first action comprises transmitting first information on a second time-frequency resource block, there at least exists one RE not belonging to the first time-frequency resource block and a second time-frequency resource block at the same time.

17. The method in a first node according to claim 16, wherein the first information is a HARQ-ACK.

18. The method in a first node according to claim 16, wherein a transport channel occupied by the first information comprises a UL-SCH.

19. The method in a first node according to claim 15, wherein when the current RRC state is RRC_INACTIVE State, the first action comprises switching to a first RRC state;
wherein the first signaling is used to de-activate the first scheduling; the first RRC state is one of RRC_INACTIVE State or RRC_IDLE State.

20. The method in a first node according to claim 15, wherein when the current RRC state is RRC_INACTIVE State, the first action comprises monitoring a second signaling in a first time window;
wherein the first signaling is used to de-activate the first scheduling; the second signaling is scheduled by a PDCCH addressed to a unicast RNTI.
